(19) United States
(12) Patent Application Publication
(10) Pub. No.: US 2007/0004395 A1
(43) Pub. Date: Jan. 4, 2007

(54) Slide mechanism for a slide-type portable terminal device

(75) Inventors: Chao Duan, Shenzhen (CN); Chia-Hua Chen, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FIH CO., LTD, Shindian City (TW)

(21) Appl. No.: 11/397,017

(22) Filed: Apr. 3, 2006

(30) Foreign Application Priority Data
Jun. 3, 2005 (CN) 200510035133.3

(51) Int. Cl. H04Q 7/20

(52) U.S. Cl. 455/422.1

(57) ABSTRACT

A slide mechanism (100) includes a main plate (20), a slide plate (10). The main plate has a post (24) protruding from one surface thereof The slide plate is slidably relative to the main plate, and has a guiding slot (162) defined therein. The post is slidably engaged with the guiding slot. The guiding slot is configured in a manner such that the post slides automatically to a desired position in the guiding slot when the post slides from one end of the guiding slot to the other and reaches a critical point.

### BACKGROUND OF THE INVENTION

1. Field of the Invention

The present invention relates to a slide mechanism of a portable terminal device, and this slide mechanism is suitably used when a first housing which constitutes a transmitter section and a second housing which constitutes a receiver section of the portable terminal device such as a cellular phone in particular are slidably coupled to each other.

2. Discussion of the Related Art

Currently, among diverse portable terminal designs, a sliding-type portable terminal device has been increasingly used. The sliding-type portable terminal is configured to have two housings. One of the housings slides over the other housing, thereby opening/closing the portable terminal device.

However, configurations of the sliding-type portable terminal device proposed so far have not been particularly popular. Moreover, manually sliding one of the housings relative to the other in order to open/close the sliding-type portable terminal device may be inconvenient. A slide mechanism is designed with the first housing being a transmitter section with a keyboard portion. The first housing is slidably laid over a second housing, which is a receiver section with a display portion and a speaker portion. The second housing slides in a longitudinal direction along the first housing thereby covering or exposing the upper surface of the first housing. The slide mechanism described in the above has two slide modules composed of a slide case made of a slide cover and a lock plate which are laid over each other and fixed together, a slider slidably accommodated in the slide case, and a leaf spring which is resiliently disposed between the slider and the slide case. The slide modules are provided in parallel on a lower surface of the second housing, and two mounting pins protrude from the slider to be fixed with screws on the upper surface of the first housing.

The above-described slide mechanism requires means for engaging the slide cover and the lock plate, which constitute the slide case, to each other. Consequently, the structure of the slide case is complex. Additionally, it is also required to caulk and fix the slide case and the lock plate to each other or to spot-weld them. As a result of the above-described complexities production cost is high.

What is needed, therefore, is a slide mechanism of a portable terminal device which, having a minimal number of parts and keeping the same function as that of a conventional one, enables a substantial reduction in production cost.

### SUMMARY OF THE INVENTION

In one aspect, a slide mechanism is provided. The slide mechanism includes a main plate and a slide plate. The main plate has a post protruding from one surface thereof The slide plate is slidably laid over the main plate, and has a guiding slot defined therein. The post is slidably engaged with the guiding slot. The guiding slot is configured in a manner such that as the post slides from one end of the guiding slot to the other, resilient deformation occurs. After the post passes through a critical point from either of two directions, rebounding occurs thereby automatically urging the post to a desired position in the guiding slot.

Other advantages and novel features will become more apparent from the following detailed description when taken in conjunction with the accompanying drawings.

### BRIEF DESCRIPTION OF THE DRAWINGS

Many aspects of the slide mechanism can be better understood with reference to the following drawings. The components in the drawings are not necessarily drawn to scale, the emphasis instead being placed upon clearly illustrating the principles of the present slide mechanism. Moreover, in the drawings, like reference numerals designate corresponding parts throughout the several views.

FIG. 1 is a perspective view illustrating a closed state of a sliding-type mobile phone, to which a slide mechanism according to a first preferred embodiment of the present invention is applied;

FIG. 2 is a perspective view illustrating an opened state of the second housing in the sliding-type mobile phone illustrated in FIG. 1;

FIG. 3 is an exploded, perspective view of the sliding mechanism of FIG. 1, including a slide plate and a main plate;

FIG. 4 is a perspective, assembled view of the sliding mechanism of FIG. 3;

FIG. 5 is an inverted explanatory view showing the slide plate being moved to closed position relative to the main plate;

FIG. 6 is similar to FIG. 5 but showing the slide plate at a half-closed position relative to the main plate;

FIG. 7 is similar to FIG. 5 but showing the slide plate in an open position relative to the main plate; and

FIG. 8 is a perspective, assembled view of a sliding mechanism according to a second preferred embodiment of the present invention.

### DETAILED DESCRIPTION OF PREFERRED EMBODIMENTS

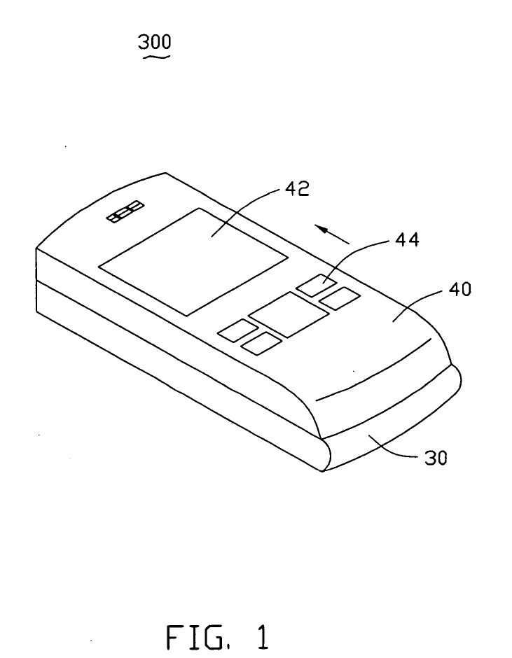

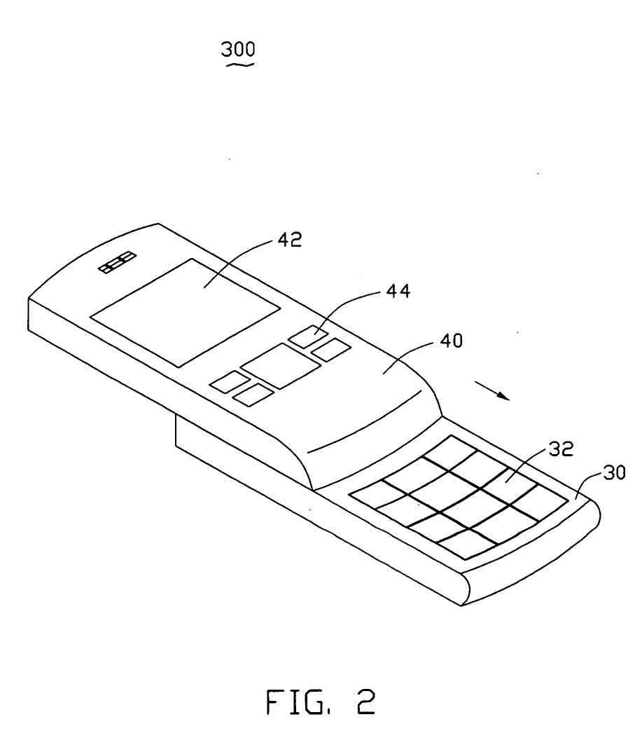

A slide mechanism according to a preferred embodiment of the present invention is adapted for use in sliding-type portable terminals such as a mobile phone 300. Referring to FIGS. 1 and 2, the mobile phone 300 includes a first housing 30, a second housing 40 engaged with the first housing 30 in a face-to-face relationship, and a slide mechanism 100 between the first and second housings 30 and 40 for generating an elastic force sufficient to slide the first and second housings 30 and 40 relative to one another between closed and open positions. The first housing 30 is provided, at a front surface thereof, with a keypad 32. The second housing 40 is provided, at a front surface thereof, with a display 42 and a plurality of function keys 44. The second housing 40 slides lengthwise over the first housing 30, thus exposing or covering the keypad 32.

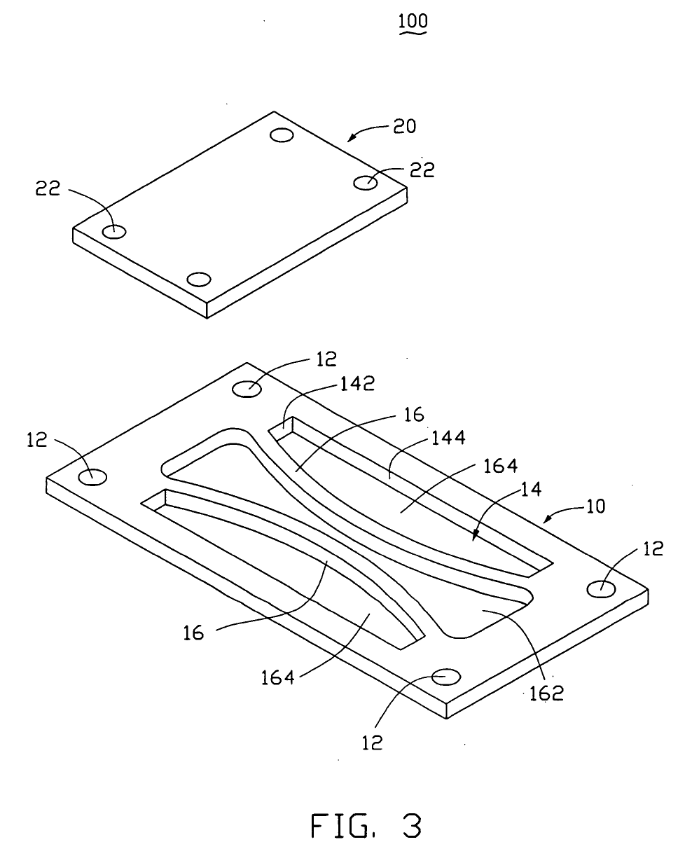

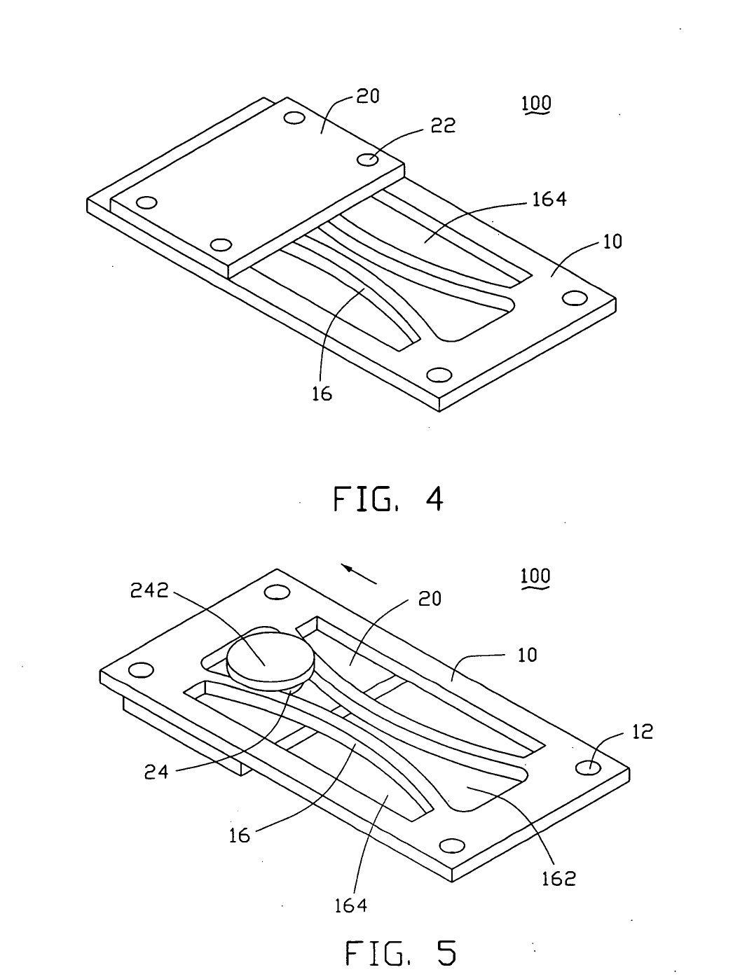

Referring now to FIGS. 3-4, the slide mechanism 100 includes a slide plate 10and a main plate 20. The slide plate 10 and the main plate 20 are respectively fixed with the second housing 40 and the first housing 30.

The slide plate 10 is substantially rectangular shaped. The slide plate 10 has four first fixation holes 12 respectively defined in securing portions formed in four corners thereof, for fixing the slide plate 10 to the second housing 40. The slide plate 10 has a substantially rectangular opening 14 in the middle thereof defined by two opposite first sides 142 and two opposite second sides 144. A length of each second side 144 is longer than that of each first side 142. The slide plate 10 has two arched elastic plates 16 extending from one of the two first sides 142 to the other of the two first sides 142. The two elastic plates 16 are symmetrically disposed and spaced by a distance in such a manner that a distance between thereof gradually increases from a middle to two ends. Thus, a guiding slot 162 is formed and defined by the two elastic plates 16. The breadth of the guiding slot 162 gradually increases from the middle thereof to the ends. Therefore, the rectangular opening 14 is divided into two arched openings 164 respectively disposed adjacent the guiding slot 162. Each arched opening 164 is defined by a second side 144 and an elastic plate 16.

The length of the main plate 20 is shorter than that of the slide plate 10. The slide plate 10 is slidable relative to the main plate 20. The main plate 20 is substantially rectangular shaped. The main plate 20 has four second fixation holes 22 defined in securing portions formed in four corners thereof, for fixing the main plate 20 to the first housing 30. The main plate 20 has a cylindrical post 24 protruding from a middle of a surface thereof. The cylindrical post 24 is provided with a flange 242 at a distal end thereof. When the cylindrical post 24 is received in the guiding slot 162, the flange 242 resists the elastic plates 16, for preventing the cylindrical post 24 from falling from the guiding slots 162, and securely fixed in a slot of the second housing 40. The cylindrical post 24 is received by and slidable in the guiding slot 162. A height of the cylindrical post 24 is equal to or slightly greater than a thickness of the elastic plate 16. A diameter of the cylindrical post 24 is greater than a breadth of the middle of the guiding slot 162, and is smaller than a breadth of ends of the guiding slot 162.

In assembly, the cylindrical post 24 of the main plate 20 is received in an end of the guiding slot 16 of the slide plate 10. In this position, the elastic plates 16 are in a relaxed state.

Referring to FIGS. 1-2 and FIG. 5, the slide plate 10 is fixed to the second housing 40 of the mobile phone 300 via the first fixation holes 12, and the main plate 20 is fixed to the first housing 30 of the mobile phone 300 via the second fixation holes 22. The cylindrical post 24 of the main plate 20 is received in one end of the guiding slot 16 of the slide plate 10. The flange 242 securely fixed in the slot of the second housing 40 such that the second housing 40 cannot become detached from the first housing 30. The second housing 40 is laid over the first housing 30, and the second housing 40 covers the keypad 32 of the first housing 30 as shown in FIG. 2. The elastic plates 16 are in a relaxed state and the main plate 20 and the slide plate 10 are in a closed position as shown in FIG. 5.

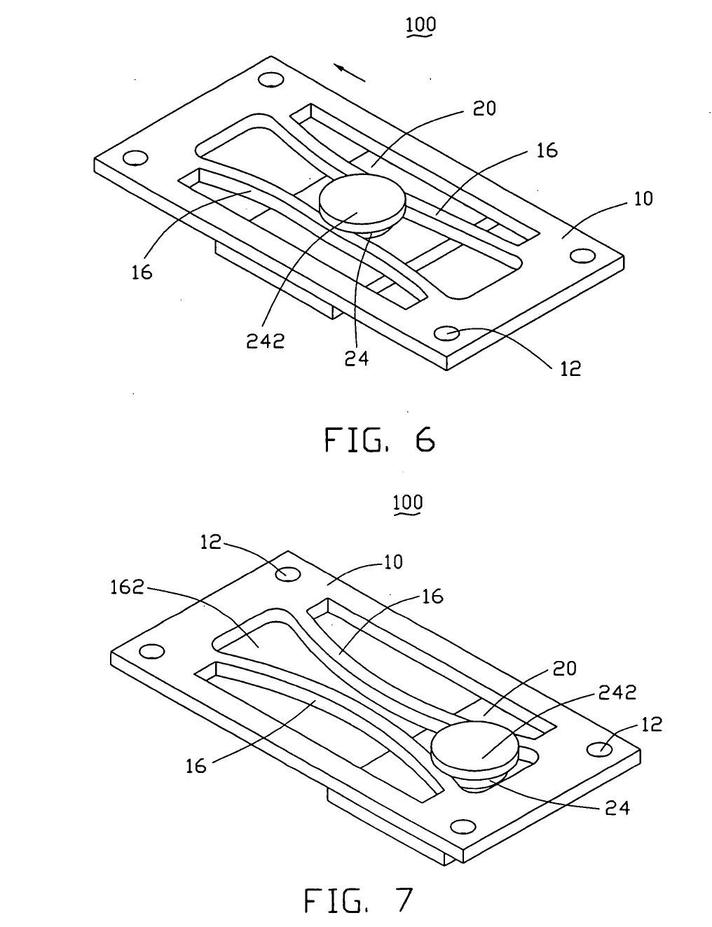

Referring also to FIGS. 6-7, when the second housing 40 is pushed in a direction of the arrow shown in FIG. 1, that is toward an open position as shown in FIG. 7, in order for operating the keypad 32 of the first housing 30, the slide plate 10 slides relative to the main plate 20 as indicated by a direction of the arrow shown in FIG. 5. Therefore, the cylindrical post 24 of the main plate 20 slides, relative to the slide plate 10, in the guiding slot 162 of the slide plate 10. Thus, the two elastic plates 16 of the slide plate 10 are deformed, thereby accumulating elastic force in opposition to the direction of movement until a middle of the guiding slot 162 is reached. When the post 24 reaches the middle of the guiding slot 162 as shown in FIG. 6, the elastic plates 16 are at their most deformed, thereby storing a maximum elastic force centered on the post 24. At this time, if the second housing 40 is pushed in either longitudinal direction away from the middle, the elastic force is released in the direction of movement and the slide plate 10 has a tendency to slide under the influence of the elastic force of the elastic plates 16 to either the open position of FIG. 7 or the closed position of FIG. 5 corresponding to the direction of movement. If the movement continues in the direction as indicated by the arrow in FIG. 5 the second housing 40 is opened completely, relative to the first housing 30. Consequently, as shown in FIG. 2, the keypad 32 on the first housing 30 is exposed so as to be able to be operated. The process of closing the second housing 40 is reverse of the opening process of the second housing 40.

Alternatively, the two elastic plates 16 can be other kinds of separate elastic members, such as an arched elastic rubber stick. The slide plate 10 defining two arcuate slots extending from the two first sides 122, for receiving and fixing two ends of each elastic rubber stick. Also, the flange 242 of the cylindrical post 24 can be omitted, and the diameter of the cylindrical post 24 is slightly greater than a breadth of ends of the guiding slot 162. Therefore, when the cylindrical post 24 of the main plate 20 is received in an end of the guiding slot 162 of the slide plate 10. In this position, the elastic plates 16 are in a slightly compressed state and can be securely engaged in the guiding slot 162 such that the second housing 40 is attached to the first housing 30.

In the embodiments described above, a main advantage of the slide mechanism 100 is that it has only three main components, and occupies a relatively small volume. Accordingly, the space required in an application such as a mobile phone 300 is reduced. In addition, the second housing 40 semi-automatically slides relative to the first housing 30 between the open and closed positions in response to the elastic force produced by the elastic plates 16. Therefore, a user can use the sliding-type portable terminal conveniently

In the above-mentioned embodiments, the middle of the slot is a critical point, and the guiding slot is symmetrical about the critical point. That is, when the post slides from one end of the guiding slot to the other and reaches this critical point, the post slides automatically to a desired position in the guiding slot. Understandably, the critical point may be set at any other suitable position between the two ends, in which case the guiding slot may not be symmetrical about the critical point.

It can be seen that the slide plate 10 and the main plate 20 can be integrally with the second housing 40 and the first housing 10 respectively.

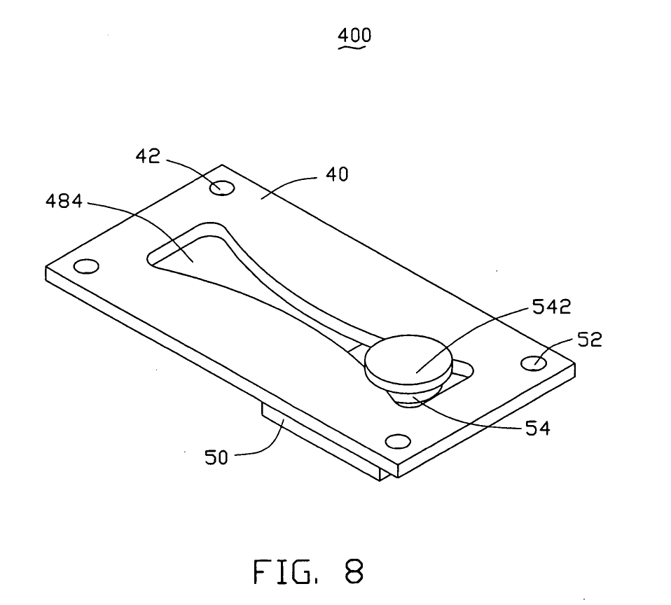

Referring to FIG. 8, a slide mechanism 400 is provided according to a second preferred embodiment of the present invention. In this illustrated embodiment, the slide mechanism 400 includes a slide plate 40 and a main plate 50. The slide plate 40 defines only one guiding slot 484 or groove of which configuration is similar to the guiding slot 162. The main plate has a cylindrical elastic post 54 projecting from one surface thereof opposite to the slide plate 40. When the slide plate 40 slides relative to the main plate 50, the cylindrical elastic post 54 slides in the guiding slot and is compressed to accumulate elastic force, which drives the slide plate 40 to automatically slide from a middle of the guiding slot 484 to one end of the guiding slot 484.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A slide mechanism, comprising:
a main plate having a post protruding from one surface thereof; and
a slide plate slidably laid over the main plate and having a guiding slot defined therein, the post slidably engaging with the guiding slot, the guiding slot being configured in a manner such that the post slides automatically to a desired position in the guiding slot when the post slides from one end of the guiding slot to the other and reaches a critical point.

2. The slide mechanism as claimed in claim 1, wherein the slide plate has an elastic member formed thereon adjacent to the guiding slot, and the elastic member provides an elastic force which drives the post to slide relative to the slide plate when the post slides to the critical point in the guiding slot.

3. The slide mechanism as claimed in claim 2, wherein the elastic member comprises two arched elastic plates extending from the slide plate, the guiding slot defined by the elastic plates and the slide plate.

4. The slide mechanism as claimed in claim 2, wherein the elastic member comprises an arched elastic plate extending from the slide plate.

5. The slide mechanism as claimed in claim 2, wherein the elastic member comprises two arched rubber sticks, each end of each arched rubber stick is fixed with the slide plate.

6. The slide mechanism as claimed in claim 1, wherein the post is elastic, and the post elastically deforms to such an extent that the elastic post slides automatically relative to the main plate as the post slides to the critical point in the guiding slot.

7. The slide mechanism as claimed in claim 1, wherein a breadth of the guiding slot gradually increases from a middle thereof to two ends thereof, a diameter of the post is larger than a breadth of the middle of the guiding slot, and equal to a breadth of two ends of the guiding slot, the critical point of the guiding slot is in the middle.

8. A slide-type mobile terminal comprising:
a first housing;
a second housing slidably installed on the first housing; and
a slide mechanism installed between the first housing and the second housing for guiding a sliding motion of the second housing in relation to the first housing, comprising:
a main plate having a post protruding from one surface thereof;
a slide plate slidably laid over the main plate and having a guiding slot defined therein, the post slidably engaging with the guiding slot, the guiding slot being configured in a manner such that the post slides automatically to a desired position in the guiding slot when the post slides from one end of the guiding slot to the other and reaches a critical point.

9. The slide mechanism as claimed in claim 8, wherein the slide plate has an elastic member formed thereon adjacent to the guiding slot, and the elastic member provides an elastic force which drives the post to slide relative to the slide plate when the post slides to the desired position in the guiding slot.

10. The slide mechanism as claimed in claim 9, wherein the elastic member comprises two arched elastic plates extending from the slide plate, the guiding slot defined by the elastic plates and the slide plate.

11. The slide mechanism as claimed in claim 9, wherein the elastic member comprises an arched elastic plate extending from the slide plate.

12. The slide mechanism as claimed in claim 9, wherein the elastic member comprises two arched rubber sticks, each end of each arched rubber stick is fixed with the slide plate.

13. The slide mechanism as claimed in claim 8, wherein the post is elastic, and the post elastically deforms to such an extent that the elastic post slides automatically relative to the main plate as the post slides to a desired position in the guiding slot.

14. The slide mechanism as claimed in claim 8, wherein a breadth of the guiding slot gradually increases from a middle thereof to two ends thereof, a diameter of the post is larger than a breadth of the middle of the guiding slot, and equal to a breadth of two ends of the guiding slot.

15. The slide mechanism as claimed in claim 8, wherein the slide plate has a securing portion engaging with one of the first housing and the second housing.

16. The slide mechanism as claimed in claim 8, wherein the main plate has a fixation portion r engaging with the other one of the first housing and the second housing.

17. A slide mechanism, comprising:
a main plate having a post protruding from one surface thereof, and
a slide plate slidably laid over the main plate, the slide plate comprising a plate portion defining a guiding slot therein, the post slidably engaging in the guiding slot and with the plate portion, one of the plate portion and the post being elastic, the shape of the guiding slot being configured such that when the post is initially manually moved relative to the slide plate toward a desired position in the guiding slot, said one of the plate portion and the post elastically deforms to such an extent that allows the post to automatically slide to said desired position.

18. The slide mechanism as claimed in claim 17, wherein the plate portion is an elastic member formed thereon adjacent to the guiding slot, and the elastic member provides an elastic force which allows the post to automatically slide to said desired position.

19. The slide mechanism as claimed in claim 18, wherein the elastic member comprises two arched elastic plates extending from the slide plate, the guiding slot defined by the elastic plates and the slide plate.

20. The slide mechanism as claimed in claim 17, wherein the post is elastic, and the post elastically deforms to such an extent that allows the post to automatically slide to said desired position.
